(19) United States
(12) Patent Application Publication
(10) Pub. No.: US 2018/0266476 A1
(43) Pub. Date: Sep. 20, 2018

(54) FIXING ELEMENT

(71) Applicant: fischerwerke GmbH & Co. KG, Waldachtal (DE)

(72) Inventors: Martin LINKA, Horb a.N. (DE); Thomas FOERMER, Horb-Bildechingen (DE)

(21) Appl. No.: 15/571,224

(22) PCT Filed: May 2, 2016
(86) PCT No.: PCT/EP2016/059730

§ 371 Date: Nov. 1, 2017

(30) Foreign Application Priority Data
May 27, 2015 (DE) 10 2015 108 302.7

(51) Int. Cl. F16B 37/04

(52) U.S. Cl. CPC F16B 37/045

(57) ABSTRACT

A fixing element having a fixing nut and a mounting sleeve for fixing an article to a mounting rail. The fixing nut is held in a nut receiver which is defined by two mutually oppositely located side members. On a first side member of the nut receiver there is arranged a resilient limb which resiliently urges the fixing nut in a direction towards the spacer element, and no resilient limb is arranged on the second side member.

The invention relates to a fixing element having the features of the preamble of claim 1.

European patent application EP 2 275 694 A1 discloses a fixing element with which an article can be fixed to a mounting rail. Mounting rails are usually used for installing lines in buildings, for example for laying suspended pipes of supply lines by means of pipe clips. Typical mounting rails have a rectangular cross-section with a slot-like longitudinal opening running in the longitudinal direction of the rail, which opening is defined by opening edges. The fixing element has a fixing nut which is inserted into the longitudinal opening and can be positioned by rotation through 90° about a longitudinal axis of the fixing element so that it engages behind the edges of the opening, with the result that the fixing nut is fixed against the mounting rail, the fixing nut being supported by a bearing surface on an outer side of the mounting rail. The fixing nut is held in a receiving opening of a sleeve-like spacer element on which the bearing surface is formed. The fixing nut has a threaded bore into which a screw or a threaded rod can be screwed and the article fixed. In order to be able to clamp the fixing nut against the edges of the opening, the fixing nut is mounted in the receiving opening on bow-like resilient limbs which connect two side members of the receiving opening to one another. A disadvantage of that fixing element is that the resilient displacement of the fixing nut is relatively small in relation to the necessary axial overall height.

U.S. Pat. No. 4,460,299 discloses a generic fixing element which instead of two bow-like resilient limbs has two resilient limbs which engage cantilever-like around the fixing nut and press against the fixing nut from below. However, the resilient limbs engage in the fixing nut, thus limiting the resilient displacement that is possible.

The problem of the invention is to propose an alternative fixing element which allows a large degree of resilient displacement while having a small overall height.

That problem is solved according to the invention by a fixing element having the features of claim 1. The fixing element according to the invention has a fixing nut and a mounting sleeve for fixing an article to a mounting rail. The article can be, for example, a pipe clip or an angle piece or connecting piece with which two mounting rails can be joined to one another. The fixing nut is especially made of metal and has a length that is greater than its width and its height. The fixing nut is shaped so that it can be inserted into a complementary opening in the mounting rail and fixed in the mounting rail by rotation about a longitudinal axis of the fixing element, the fixing nut engaging behind edges of the opening. The fixing nut especially has a threaded bore into which a screw or a threaded rod can be screwed and the article fixed to the mounting rail. The longitudinal axis of the fixing element especially runs parallel to the direction of insertion of the fixing element into the opening and especially normally with respect to the longitudinal axis of the rail. The mounting sleeve comprises a collar-like bearing surface for contact with the mounting rail, a nut receiver for receiving the fixing nut and a spacer element having a screw receiver extending along a longitudinal axis. The spacer element is especially made from plastics material and especially has the shape of a hollow cylinder. The screw receiver serves for receiving a screw or a threaded rod for fixing the article to the mounting rail, the screw receiver especially passing through the spacer element so that a screw can be screwed through the screw receiver into a threaded bore of the fixing nut. The collar-like bearing surface projects from the spacer element in the radial direction in relation to the longitudinal axis, the term “collar-like” not necessarily meaning that the bearing surface projects from the spacer element in all directions and/or is in the form of a circular ring. The nut receiver is arranged at the end of the spacer element located opposite the bearing surface and has a receiving opening which is defined at its sides by two mutually oppositely located side members. The side members are especially of column-like construction and especially extend parallel to the longitudinal axis away from the spacer element. Between the side members the fixing nut is held so as to be fixed against rotation relative to the spacer element but axially movable in relation to the longitudinal axis. That is to say, the fixing nut can be moved axially in the nut receiver relative to the spacer element, but can be rotated about the longitudinal axis only together with the spacer element. In order to be able to clamp the fixing element against the edges of an opening of a mounting rail there is arranged on a first side member of the nut receiver a resilient limb which resiliently urges the fixing nut in a direction towards the spacer element in such a way that the fixing nut can be moved axially away from the spacer element against the spring force of the resilient limb.

It is characteristic of the fixing element according to the invention that on the second side member there is arranged no resilient limb which resiliently urges the fixing nut in a direction towards the spacer element. That means, in particular, that no resilient limb projects into the receiving opening from the side of the nut receiver on which the second side member is arranged. The resilient limb arranged on the first side member is connected only to the first side member and projects cantilever-like into the receiving opening. If a plurality of resilient limbs are formed on the nut receiver, they project into the receiving opening from the same side of the nut receiver, it not being necessary for the resilient limbs all to be connected to the second side member. Further side members, to which the resilient limbs are connected, can be arranged on the side of the nut receiver on which the first side member is arranged. That means that the resilient limb(s) project by their free end(s) into the receiving opening and are connected by their other end(s) to the first side member or to a further side member which is located on the side of the nut receiver on which the first side member is arranged. A separate side member can be provided for each resilient limb. If a plurality of resilient limbs are provided, they can run parallel to one another. The resilient limbs can also all be arranged on the first side member. The second side member acts as guide for the fixing nut during axial movement. Since there are no resilient limbs arranged on the second side member, an axial movement of the fixing nut has no effect on the side member acting as guide, while the first side member, on which the resilient limb is arranged, can be deformed during an axial movement of the fixing nut, this especially being the case in the event of a relatively large axial movement. Accordingly, even in the case of a relatively large axial movement the fixing nut is guided by the second side member during the axial movement and held thereby during a rotational movement. Nevertheless, the required overall height of the fixing element according to the invention is small.

The fixing nut is held in the receiving opening preferably by means of the resilient limb. That is to say, the fixing nut and the mounting sleeve are captively connected to one another by the clamping action alone, thus allowing simple mounting of the fixing element.

In a preferred embodiment of the fixing element according to the invention the first side member and the resilient limb are rigidly connected to one another. In particular, the first side member and the resilient limb form a rigid frame corner. During an axial movement of the resilient limb with the fixing nut in an axial direction away from the spacer element, the first side member is moved radially outwards as a result of the rigid connection, the resilient limb and the first side member being jointly resiliently deformed. By virtue of the joint resilient deformation, the fixing nut is able to move axially away from the spacer element to a greater extent than if solely the resilient limb were to be deformed. The fixing nut is nevertheless reliably guided during the movement by means of the second side member which, on account of the absence of a resilient limb, is not deformed.

Preferably the first side member forms a first bearing surface for a first side wall of the fixing nut and/or the second side member forms a second bearing surface for a second side wall of the fixing nut. In particular, the bearing surface or the bearing surfaces and the side wall or the side walls are in the form of complementary, especially flat, surface(s), thus ensuring good contact between the fixing nut and the first and/or second side wall(s).

In a further preferred embodiment of the fixing element according to the invention, especially in a non-clamped state in which the fixing nut is especially in contact with the spacer element, the second side member projects beyond the front face of the fixing nut remote from the spacer element. The second side member accordingly has a length which allows good guidance even in the case of a large axial movement of the fixing nut.

Furthermore, it is preferable for there to be arranged on the first side member two resilient limbs which resiliently urge the fixing nut in a direction towards the spacer element. The provision of two resilient limbs on the first side member promotes a uniform action of the resilient limbs on the fixing nut, thus allowing uniform movement of the fixing nut in the nut receiver.

In a preferred embodiment of the fixing element according to the invention, the first side member and/or the second side member has, at least in sub-regions, a circular-segment-shaped cross-section with a curved peripheral surface. In particular, in the region of the side members the nut receiver has a diameter which substantially corresponds to the diameter of an incircle inscribed in the opening of the mounting rail into which the fixing element is introduced. In particular, the diameter of the nut receiver in the region of the side members corresponds to the diameter of the spacer element which especially has, at least in sub-regions, a cylindrical wall surface, so that the side walls and/or the spacer element guide the fixing element during rotation about the longitudinal axis once the fixing element has been inserted into an opening of the mounting rail.

Once a fixing element has been inserted into an opening of a mounting rail, in order to prevent the fixing element from being turned too far during rotation about the longitudinal axis the fixing element has at least two stop elements which are especially arranged on the spacer sleeve and preferably project radially from the wall surface of the spacer sleeve. The stop elements are arranged on the spacer element mirror-symmetrically with respect to the longitudinal axis and, by making contact with the edges of the opening, prevent the fixing element from being turned too far.

Preferably, for better guidance, there can be arranged on the second side member a guide element which is in contact with the fixing nut. In particular, the guide element is in the form of a guide rib. In particular, the guide element extends over the entire height of the second side member.

The invention is explained in greater detail below with reference to an exemplary embodiment shown in the drawing, wherein:

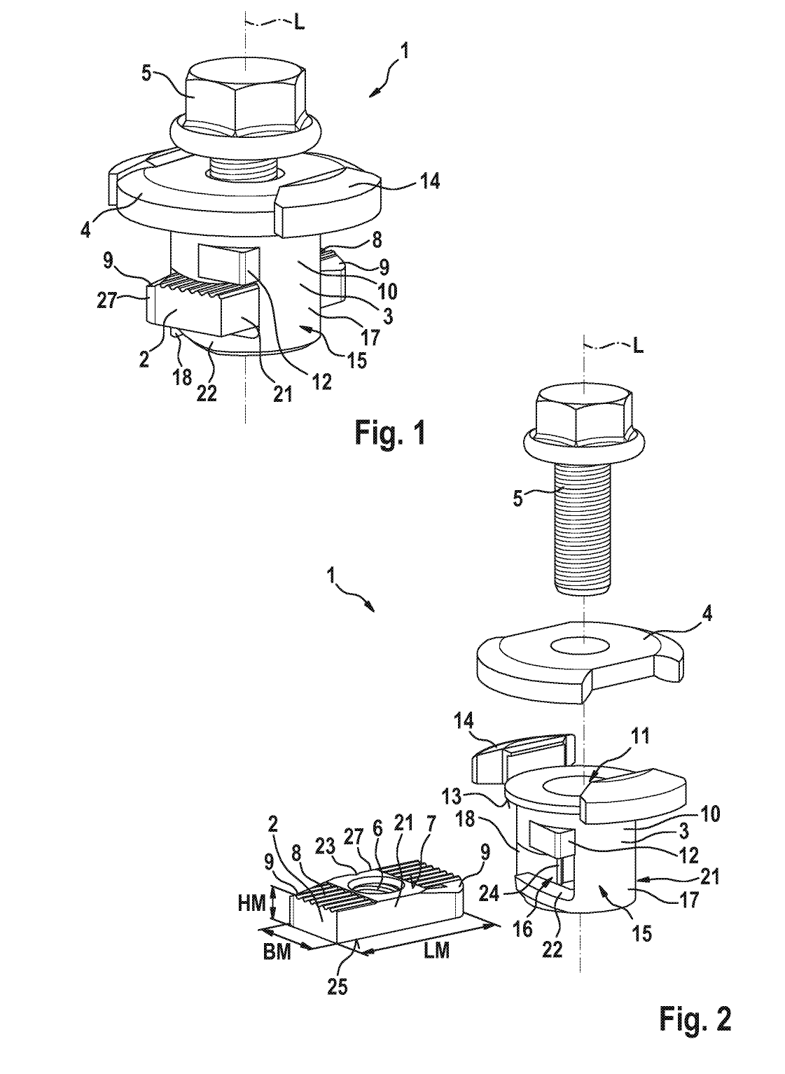

FIG. 1 is a perspective view of a fixing element according to the invention;

FIG. 2 is an exploded view of the fixing element according to the invention;

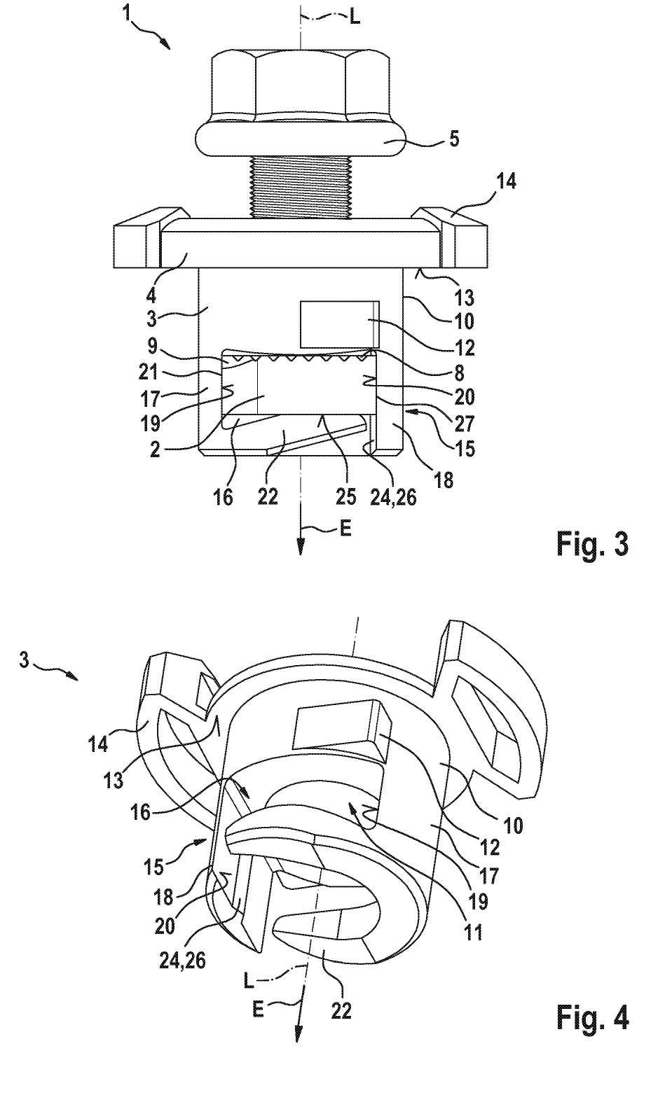

FIG. 3 shows the fixing element according to the invention in elevation; and

FIG. 4 is a perspective view of a portion of a mounting sleeve of the fixing element according to the invention.

The fixing element 1 shown in FIGS. 1 to 3 extends along a longitudinal axis L and consists of a fixing nut 2, a mounting sleeve 3, a clamping plate 4 and a screw 5.

As can be seen especially in FIG. 2, the fixing nut 2 has the shape of an elongated parallelepiped, having a length LM that is greater than its width BM and its height HM. Arranged centrally in the fixing nut 2 there is a threaded bore 6 which passes through the fixing nut 2 in the direction of its height HM or the longitudinal axis L and into which the screw 5 has been screwed. On a rear face 7 of the fixing nut 2, which face is to the rear in the introduction direction E, there is arranged a profiled surface 8 for engagement in complementary ribbing which is typically formed on the edges defining an opening of a mounting rail (not shown). The introduction direction E is the direction in which the fixing element 1 is introduced as intended into an opening of a mounting rail. It runs substantially parallel to the longitudinal axis L or lies thereon. Two corners 9 of the rear face 7 of the fixing nut 2, which corners are located opposite one another in relation to the longitudinal axis L, have a wedge-shaped bevel. The fixing nut 2 has two side walls 21, 27. A triangular guide groove 23, which runs in the direction of the height HM, is arranged centrally in the second side wall 27.

The mounting sleeve 3 consists of a spacer element 10, which is of hollow-cylindrical construction and has a screw receiver 11 which extends along the longitudinal axis L and through which the shank of the screw 5 passes for screwing into the threaded bore 6 of the fixing nut 2. The spacer element 10 has a cylindrical wall surface on which there are arranged two stop elements 12 which project radially from the wall surface. The stop elements 12 are of wedge-shaped construction and are arranged on the spacer element 10 mirror-symmetrically with respect to the longitudinal axis L. On the spacer element 10, at its rear end in the introduction direction E, there is formed a collar-like bearing surface 13 which projects radially from the spacer element 10 and comprises two tabs 14 with which the clamping plate 4 is held clamped against the mounting sleeve 3. At the end of the spacer element 10 located opposite the bearing surface 13 there is arranged a nut receiver 15 having a slot-like receiving opening 16 which is defined by two mutually oppositely located side members 17, 18. The fixing nut 2 is held between the side members 17, 18 so as to be fixed against rotation but axially movable in relation to the longitudinal axis L. The surfaces of the side members 17, 18 that face towards the fixing nut 2 form flat bearing surfaces 19, 20 for the side walls 21, 27 of the fixing nut 2. On the second bearing surface 20 of the second side member 18 there is arranged as guide element 26 a guide rib 24 which has a triangular cross-section complementary to the guide groove 23 of the fixing nut 2 and which extends substantially over the axial extent of the second side member 18. The side members 17, 18 project beyond the front face 25 of the fixing nut 2 in the introduction direction E. The outer surfaces of the side members 17, 18 are matched to the wall surface of the cylindrical spacer element 10 so that the side members 17, 18 have a substantially circular-segment-shaped cross-section with a curved peripheral surface.

On the first side member 17 of the nut receiver 15 there are arranged two resilient limbs 22 which resiliently urge the fixing nut 2 in a direction towards the spacer element 10, that is to say in a direction opposite to the introduction direction E. The two resilient limbs 22 run parallel to one another and both project into the receiving opening 16 from the side of the nut receiver 15 on which the first side member 17 is arranged and bear against the front face 25 of the fixing nut 2. The two resilient limbs 22 support the fixing nut 2 against movement in the introduction direction E, with the result that the fixing nut 2 is held clamped in the receiving opening 16. The guide groove 23 of the fixing nut 2 engages the guide rib 24 and accordingly prevents displacement of the fixing nut 2 in the receiving opening 16 transversely with respect to the longitudinal axis L. The resilient limbs 22 are rigidly connected to the first side member 17 and together with the first side member 17 form a rigid frame corner, so that during a movement of the resilient limbs 22 in the introduction direction E the front end of the first side member 17 in the introduction direction E is bent radially outwards. Since, during a movement of the fixing nut 2 in the introduction direction E, the first side member 17 is deformed together with the resilient limb 22 it is possible to achieve a large degree of resilient displacement even with a small overall height of the fixing element 1. The second side member 18 having the guide rib 24 is located on the side of the nut receiver 15 located opposite the first side member 17. No resilient limbs are arranged on this second side member 18. Accordingly, no resilient limb resiliently urging the fixing nut 2 in a direction opposite to the introduction direction E projects into the receiving opening 16 from the side of the nut receiver 15 on which the second side member 18 is arranged. The fixing nut 2 is resiliently urged in a direction opposite to the introduction direction E solely by the resilient limbs 22 connected to the first side member 17. Accordingly, the second side member 18 forms a stable guide for the fixing nut 2 during an axial movement along the longitudinal axis L. During a movement of the fixing nut 2 in the introduction direction E, the second side member 18 is not bent outwards but it does not change its position. Accordingly, the fixing nut 2 is held securely in the nut receiver 15 by the guide element 26 even when the first side member 17, as a result of a large movement of the fixing nut 2 in the receiving opening 16 in the introduction direction E, has been bent radially outwards and, facing towards the fixing nut 2, no longer rests entirely against the first side wall 21 of the fixing nut 2.

The fixing element 1 serves for fixing an article (not shown), for example an angle piece, to a mounting rail (not shown). For fixing, the fixing element 1 is inserted into an opening in a mounting rail until the bearing surface 13 makes contact with the mounting rail. The fixing element 1 is then rotated through 90° in the clockwise direction about the longitudinal axis L, with the result that the corners 9 of the fixing nut 2 are pressed against edges of the opening of the mounting rail and moved along those edges. As a result, the fixing nut 2 is moved in the introduction direction E and against the spring force of the resilient limbs 22 so that the resilient limbs 22 clamp the fixing nut 2 with the bearing surface 13 against the mounting rail, the second side member 18 holding the fixing nut 2 in position with the guide element 26 and guiding it during its axial movement. Once the fixing element 1 is in the desired position in the mounting rail, the fixing nut 2 is clamped with the screw 5 against the bearing surface 13 and especially against the clamping plate 4, so that an article is fixed to the mounting rail.

### LIST OF REFERENCE SYMBOLS

### Fixing Element

1 fixing element
2 fixing nut
3 mounting sleeve
4 clamping plate
5 screw
6 threaded bore
7 rear face
8 profiled surface
9 corner
10 spacer element
11 screw receiver
12 stop element
13 bearing surface
14 tab
15 nut receiver
16 receiving opening
17 first side member
18 second side member
19 first bearing surface
20 second bearing surface
21 first side wall
22 resilient limb
23 guide groove
24 guide rib
25 front face
26 guide element
27 second side wall
BM width of the fixing nut 2
E introduction direction
HM height of the fixing nut 2
L longitudinal axis
LM length of the fixing nut 2

1. A fixing element having a fixing nut and a mounting sleeve for fixing an article to a mounting rail,
wherein the fixing nut has a length that is greater than its width and its height,
wherein the mounting sleeve comprises a collar-like bearing surface for contact with the mounting rail, a nut receiver for receiving the fixing nut and a spacer element having a screw receiver extending along a longitudinal axis,
wherein the nut receiver is arranged at the end of the spacer element located opposite the bearing surface,
wherein the nut receiver has a receiving opening which is defined by two mutually oppositely located side members between which the fixing nut is held so as to be fixed against rotation relative to the spacer element but axially movable in relation to the longitudinal axis, wherein on a first side member of the nut receiver there is arranged a resilient limb which resiliently urges the fixing nut in a direction towards the spacer element, and
wherein on the second side member there is arranged no resilient limb which resiliently urges the fixing nut in a direction towards the spacer element.

2. The fixing element according to claim 1, wherein the fixing nut is held clamped in the receiving opening by means of the resilient limb.

3. The fixing element according to claim 1, wherein the first side member and the resilient limb are rigidly connected.

4. The fixing element according to claim 1, wherein the first side member forms a first bearing surface for a first side wall of the fixing nut.

5. The fixing element according to claim 1, wherein the second side member forms a second bearing surface for a second side wall of the fixing nut.

6. The fixing element according to claim 1, wherein the second side member projects beyond the front face of the fixing nut remote from the spacer element.

7. The fixing element according to claim 1, wherein there are arranged on the first side member two resilient limbs which resiliently urge the fixing nut in a direction towards the spacer element.

8. The fixing element according to claim 1, wherein the first side member and/or the second side member has, at least in sub-regions, a circular-segment-shaped cross-section with a curved peripheral surface.

9. The fixing element according to claim 1, wherein the fixing element has two stop elements which are arranged on the spacer element mirror-symmetrically with respect to the longitudinal axis.

10. The fixing element according to claim 1, wherein on the second side member there is arranged a guide element for guiding the fixing nut.
